(19) United States
(12) Patent Application Publication
(10) Pub. No.: US 2014/0378169 A1
(43) Pub. Date: Dec. 25, 2014

(54) Method And Device For Providing User Information, And Computer Storage Medium

(71) Applicant: TENCENT TECHNOLOGY (SHENZHEN) COMPANY LIMITED, Shenzhen City (CN)

(72) Inventors: Rui ZHONG, Shenzhen City (CN); Xijun DONG, Shenzhen City (CN); Han LIAN, Shenzhen City (CN); Yu LIU, Shenzhen City (CN); Jinfeng MENG, Shenzhen City (CN); Yucao TAO, Shenzhen City (CN); Boqiang WANG, Shenzhen City (CN); Wei WANG, Shenzhen City (CN); Jun YU, Shenzhen City (CN); Chunlei ZHENG, Shenzhen City (CN); Tao ZHOU, Shenzhen City (CN)

(21) Appl. No.: 14/479,621

(22) Filed: Sep. 8, 2014

Related U.S. Application Data
(63) Continuation of application No. PCT/CN2013/071326, filed on Feb. 4, 2013.

(30) Foreign Application Priority Data
Mar. 8, 2012 (CN) 201210059851.4
Mar. 8, 2012 (CN) 201210059874.5

(51) Int. Cl. H04W 4/02

(52) U.S. Cl. CPC H04W 4/02
USPC 455/456.3

(57) ABSTRACT

A method and device for providing user information, and computer storage medium are provided. In the method, acquire information relating to user position of a user, and acquire a point of interest associated with the user position. Then, acquire other users who have performed registration on the point of interest within a predetermined time period, and provide information of the other users to the user. The method and the device for providing user information and corresponding computer storage medium may select other users through POIs, and then provide information of the selected users to an active user. In this way, the other users are closely associated with the geographic location of the active user, or associated with the points of interest which the active user is interested in.

### CROSS-REFERENCE TO RELATED APPLICATIONS

This application is a continuation of International Application No. PCT/CN2013/071326 filed on Feb. 4, 2013. This application claims the benefit and priority of Chinese Patent Application No. 201210059874.5, filed Mar. 8, 2012 and Chinese Patent Application No. 201210059851.4, filed Mar. 8, 2012. The entire disclosures of each of the above applications (are) incorporated herein by reference.

### FIELD

The present disclosure relates to network communication technologies and to a method and device for providing user information, and a computer storage medium.

### BACKGROUND

This section provides background information related to the present disclosure which is not necessarily prior art.

Social contact application is one of the most extensive applications in a mobile terminal, such as a mobile phone, a tablet PC, etc.

When a user uses the social contact application, one of the most commonly used functions is to provide a user with information on strangers and allow the user to selectively add some of the strangers as friends. In the understanding of the function, an important part is how a mobile terminal provides the user with the information on other strangers. A method of providing user information, which uses existing technologies, mainly includes the following steps. First, a server tracks user position information of a user holding a mobile terminal in real time. Second, when a first user enters a certain range set by a second user, the information of the first user is provided to the second user through the mobile terminal, so that the second user can add the first user as a friend.

In the process of understanding the present disclosure, a server requires many system resources when the server tracks the position information of each user in real time. Additionally, when the information of the first user is provided to the second user, the provision is only related to the range set by the second user. It may be possible that the first user provided by the mobile terminal is not a stranger in which the second user is really interested in, that is, the first user provided may not be attractive to the second user, and therefore the possibility that the first user is added as a friend of the second user is small.

### SUMMARY

This section provides a general summary of the disclosure, and is not a comprehensive disclosure of its full scope or all of its features.

In order to reduce resource occupancy and provide users with user information in which the users are more interested, various embodiments of the present disclosure provide a method of providing user information and a device for providing user information. The technical solutions of the various embodiments are as follows.

According to various embodiments, the present disclosure provides a method for providing user information. The method includes the following:

acquiring information relating to user position of a user;

acquiring a point of interest associated with the user position;

acquiring other users who have performed registration on the point of interest within a predetermined time period; and

providing information of the other users to the user.

According to various embodiments of the present disclosure, a device for providing user information is provided. The device includes the following:

a position acquiring module, to acquire information relating to user position of a user;

a POI acquiring module, to acquire a point of interest associated with the user position;

a user acquiring module, to acquire other users who have performed registration on the point of interest within a predetermined time period; and

an information providing module, to provide information of the other users to the user;

wherein the registration includes: associating user identification information, registration time, and registered POI information of a registration initiating user to generate registration information.

According to a various embodiments, the present disclosure also provides a computer storage medium for storing executable instructions of a computer, wherein the executable instructions of the computer are configured to control the computer to implement a method of providing user information. The method includes the following:

acquiring user position information of a user;

acquiring a point of interest associated with the user position;

acquiring other users who have registered on the point of interest within a predetermined time period; and

providing information of the other users to the user.

According to various embodiments, the present disclosure also provides a method for providing user information. The method includes the following:

receiving registration of a user on a point of interest;

acquiring other points of interest associated with the point of interest;

acquiring other users registered on the point of interest and the other points of interest within a predetermined time period; and

providing information of the other users to the user, or providing information of the user to the other users.

According to various embodiments, the present disclosure also provides a device for providing user information. The device includes the following:

a POI registering module, to receive registration from a user;

a first acquiring module, to acquire other points of interest associated with the point of interest;

a user acquiring module, to acquire other users which have registered on the point of interest and the other points of interest within a predetermined time period; and

an information providing module, to provide information of the other users to the user, or provide information of the user to the other users.

According to various embodiments, the present disclosure also provides a computer storage medium for storing executable instructions of a computer, wherein the executable instructions of the computer are configured to control the computer to implement a method of providing user information. The method includes the following:

receiving registration of a user on a point of interest;

acquiring other points of interest associated with the point of interest;

acquiring other users who have registered on the point of interest and the other points of interest within a predetermined time period; and

providing information of the other users to the user, and providing information of the user to the other users.

The various embodiments of the present disclosure may provide beneficial effects as follows.

On one hand, an active user is provided with information of other users selected according to points of interest, so that the other users provided to the active user are those users closely associated with the geographic location of the active user or associated with the points of interest which the active user is interested in. In other words, the selected users are users which the active user is more interested in. The active user may acquire more useful information through communication with these users, and get to know people with the same hobbies or interests. That is, other users selected under this technical solution may fit with the active user in terms of hobbies, interests and other aspects. On the other hand, under this technical solution, a server is not needed to make real-time tracking of a position of each user, and the position of each user is identified based on registration information generated in the process of registration on the points of interest, therefore less resource is required.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

In order to more clearly describe technical solutions of the embodiments, a simple introduction of attached figures needed in description of the embodiments is made below. The figure descriptions below are only examples of the present disclosure. Those skilled in the art, on the premise of not contributing creative efforts, can obtain other figures according to these figures.

FIG. 1 is a flow chart illustrating a method of providing user information according to various embodiments of the present disclosure.

FIG. 2 is a flow chart illustrating a method of providing user information according to various embodiments of the present disclosure.

FIG. 3 is a diagram illustrating a device for implementing a method of providing user information according to various embodiments of the present disclosure.

FIG. 4 is a structure block diagram illustrating a device for providing user information according to various embodiments of the present disclosure.

FIG. 5 is a flow chart illustrating a method of providing user information according to various embodiments of the present disclosure.

FIG. 6 is a flow chart illustrating a method of providing user information according to various embodiments of the present disclosure.

FIG. 7 is a structure block diagram illustrating a device for providing user information according to various embodiments of the present disclosure.

Corresponding reference numerals indicate corresponding parts throughout the several views of the drawings.

### DETAILED DESCRIPTION

Example embodiments will now be described more fully with reference to the accompanying drawings.

In order to better clarify the purpose, technical solutions and advantages of the disclosure, the embodiments of the disclosure are further described in detail below in combination with the attached figures.

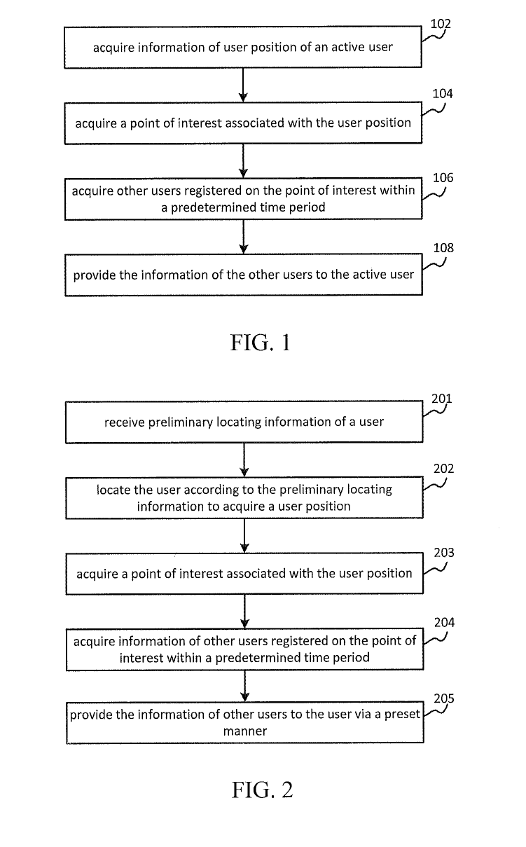

FIG. 1 shows the flow chart of a method of providing user information according to various embodiments of the present disclosure. The method of providing user information can be used in a server which may interact with multiple mobile terminals. The method of providing user information includes the following steps.

Step 102: Acquire information of a user position of an active user.

In case of the need to provide information of other users to the active user, the server can first acquire position information of the active user. For example, the active user, via a mobile terminal, sends a query request on searching for other users. The query request includes locating information provided by the mobile terminal. After receiving the query request, the server can obtain the position information of the active user according to the locating information. The user position mentioned herein usually refers to where the active user is in terms of longitude and latitude. The specific process for acquiring the information can be implemented by a GPS positioning module in the mobile terminal used by the active user, and the information is attached to the query request and passed to the server. The process can also be completed by the server according to relevant gateway information obtained when the mobile terminal used by the active user has access to a mobile network.

Step 104: Acquire point of interests (POIs) associated with the user position.

After acquiring the user position information of the active user, the server can continue to obtain points of interest associated with the user's position. A POI is a type of data relating to geographic location. Usually, each POI includes information in four aspects: name, category, longitude, and latitude. For example, a specific POI may include: name: “Tongfu Hotel”, category: “catering service”, longitude: “XX, XX”, and latitude: “YY, YY”. After obtaining the user position information of the active user, the server can obtain POIs associated with the user position information of the active user. For example, the server can obtain a plurality of POIs having a distance with the active user identified by the user position information less than a predetermined scope. In various embodiments, after acquiring the user position information of the active user, the server can obtain all other POIs within 200 meters around the user position of the active user.

Step 106: Acquire information of other users which have registered on a POI within a predetermined time period.

After obtaining one or more POIs associated with the user's location, the server can continue to obtain other users which have registered on these POIs within a predetermined time period, wherein the “registration” mainly refers to an operation which associates user identification information, registration time and registered POI information of a registration initiating user to generate registration information. For example, when User A has a meal at Tongfu Hotel at 14:59 p.m. on Feb. 8, 2012, User A may register on the POI “Tongfu Hotel” via a mobile terminal. The mobile terminal can store “User A”, “2012/2/8 14:59” and “Tongfu Hotel” as a piece of registration information. In a specific application, the “registration” may adopt other names such as Foot Printing, Sign-in, Gold Prospecting, or Name Signing. In order to obtain other users which may be as useful as possible, the “predetermined time period” may last a short period of time, such as 30 seconds, 5 minutes, or the like. During a registration process, the user can also add a message, a comment, or other information into the registration information.

For example, POI points associated with a user's location obtained in Step 104 may include: a POI point “Automatic service area of Bank of China at XX Street”, a POI point “Kedi Supermarket”, and a POI point “Century Cartoon Game Center”. A server may continue to, within 5 minutes, obtain other users having registered on the POI point “Automatic service area of Bank of China at XX Street”, the POI point “Kedi Supermarket”, and the POI point “Century Cartoon Game Center”. The registrations of these users may include: User B registering at the POI point “Automatic service area of Bank of China at XX Street” at 14:57 p.m., User C registering at the POI point “Century Cartoon Game Center” at 14:59 p.m. and attaching a message “I have passed the second pass of Taiko Drum Master”, and User D registering at the POI point “Kedi Supermarket” and adding a comment “The butter bread in this Kedi Supermarket is very delicious.”

Step 108: Provide information of other users to the active user.

After acquiring other users such as User B and User C, the server may provide the information of User B and User C to the active user. The information provided by the server normally includes at least user identification information and registered POI information, and may also include the information which can be provided such as registration time. For example, when the information on User B is provided to active User A, the information of User B may include user identification information “User B”, registered POI information “Automatic service area of Bank of China at XX Street”, and registered time “14:57”. Other information provided may include messages, comments, and information left by other users at time of registration. For example, when the information on User C is provided to active User A, the information on User C may include user identification information “User C”, registered POI information “Century Cartoon Game Center”, and message information left at the time of registration, “A user who recharges 100 game currency will be given another 100 game currency as a present !>_<!”. When the information on other users is provided to the active user, the terminal of the active user can be used, and a plurality of ways can be adopted. The ways may be audio, video, text, short message, or a combination thereof.

In conclusion, on one hand, through using the method for providing user information according to various embodiments of the present disclosure, an active user is provided with information of other users selected according to points of interest, so that the other users provided to the active user are those who are closely associated with the geographic location of the active user or associated with the points of interest which the active user is interested in. In other words, the selected users are users which the active user is more interested in. The active user may acquire more useful information through communication with these users, and get to know friends with same hobbies or interests. That is, other users selected under this technical solution fit with the active user in terms of hobbies, interests and other aspects. On the other hand, under this technical solution, a server is not needed to make real-time tracking of the position of each user, and the position of each user is identified based on the registration information generated in the process of registering points of interest, thereby lessening the resources required.

FIG. 2 illustrates a flow chart of a method of providing user information according to various embodiments of the present disclosure. The method of providing user information can be used in a server which may interact with multiple mobile terminals. The method of providing user information includes the following steps.

Step 201: Receive preliminary locating information of a user.

An active user can send a query request on searching for other users via a mobile terminal. After receiving the query request, a server can obtain the user position information of the active user. The user position mentioned herein usually refers to information on where the user is in terms of longitude and latitude. In some embodiments, a GPS positioning module in the mobile terminal used by the active user can first obtain the position information of the active user, that is, the position information on where the user is in terms of longitude and latitude, and then the information is attached to the query request and passed to a server. In other words, the server may receive from a user a query request which may directly include user position information of an active user. The server can parse the query request to directly obtain the user position of the active user. However, in various embodiments, an active user can send a query request on searching for other users via a mobile terminal. The query request may only include preliminary locating information which may be gateway information obtained when the mobile terminal used by the active user has an access to a mobile network, or may be base station information of a mobile communication network community where the mobile terminal used by the active user is located.

Step 202: Obtain user position information of a user according to preliminary locating information.

The server can obtain the information on the position of a user according to the received preliminary locating information. More specifically, after receiving the query request, the server can parse the query request and get the preliminary locating information which may be gateway information obtained when the mobile terminal used by the active user has access to a mobile network, or other information which can represent the user position of the active user. Under the support of a Geographic Information System (GIS) platform, the server may convert the preliminary locating information to information on latitude and longitude, thus obtaining the user position of the active user.

Step 203: Obtain POIs associated with the user position.

After acquiring the user position information of the active user, the server can continue to obtain POIs associated with the user's position. After acquiring the user position information of the active user, the server can continue to obtain POIs associated with the active user's position. For example, the server can obtain a plurality of POIs having distance with the position of the active user less than a predetermined range. In various embodiments, after acquiring the user position information of the active user, the server can obtain all other POIs within 200 meters around the user position of the active user. It should be noted that, the POIs associated with the user's position mentioned herein may be points of interest relating to geographical position of the user, or may be other points of interest relating to the user's geographical position or other aspects. For example, in various embodiments, the active user may be preset to provide an associated category, for example, “catering service”. When the server obtains POIs relating to the user position, the server can obtain all POIs under the category of “catering service” within 200 meters around the user position of the active user.

Step 204: Obtain other users which have registered on the POI within a predetermined time period.

After obtaining one or more POIs associated with the user's position, the server can continue to obtain other users which have registered on these POIs within a predetermined time period. The registration mainly refers to an operation which associates user identification information, registration time, and registered POI information of a registration initiating user, to generate registration information. For example, when User A has a meal at Tongfu Hotel at 14:59 p.m. on Feb. 8, 2012, User A may register on the POI of Tongfu Hotel via a mobile terminal. The mobile terminal can store “User A”, “2012/2/8 14:59” and “Tongfu Hotel” as a piece of registration information. In a specific application, the registration herein may adopt other names such as Foot Printing, Sign-in, Gold Prospecting, and Name Signing. In order to find other users which may be as useful as possible, the predetermined time period herein generally lasts a short period of time, such as 30 seconds, 5 minutes, and the like. During a registration process, the user can also add a message, a comment, or other information into the registration information.

In various embodiments, after POIs associated with a user's location are obtained in Step 203, which include: a POI of “Automatic service area of Bank of China at XX Street”, a POI of “Kedi Supermarket”, and a POI of “Century Cartoon Game Center”, a server may continue to, within 5 minutes, obtain other users having registered on the POI of “Automatic service area of Bank of China at XX Street”, the POI of “Kedi Supermarket”, and the POI of “Century Cartoon Game Center”. These users having registered on the POIs may include: User B registering at the POI of “Automatic service area of Bank of China at XX Street” at 14:57 p.m., User C registering at the POI of “Century Cartoon Game Center” at 14:59 p.m. and attaching a message “I have passed the second pass of Taiko Drum Master”, and User D registering at the POI of “Kedi Supermarket” and adding a comment “The butter bread in this Kedi Supermarket is very delicious.”

Step 205: Provide other user's information to the active user through a predetermined way.

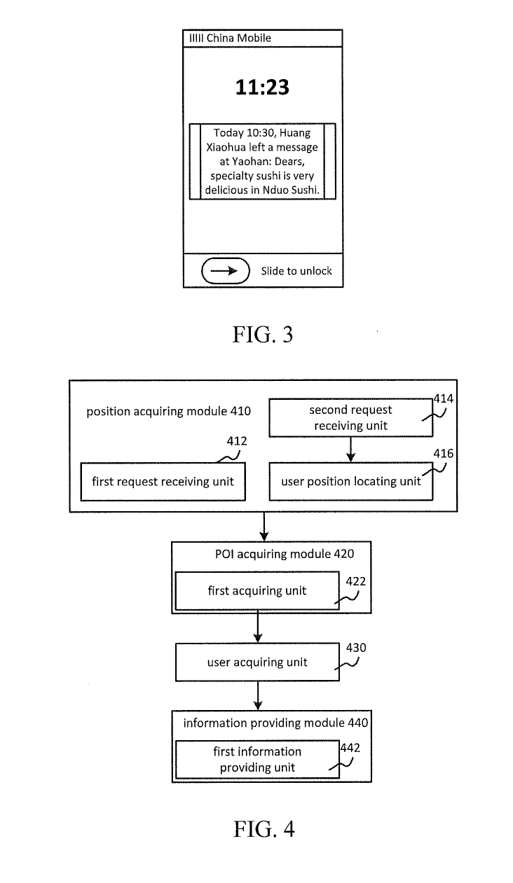

After acquiring the information on other users such as User B and User C, the server may provide the information of User B and User C to the active user. The information provided by the server normally includes at least user identification information and registered POI information, and may also include the information to be provided, such as a registration time. For example, when the information on User B is provided to active User A, the information of User B may include user identification information “User B”, registered POI information “Automatic service area of Bank of China at XX Street”, and registered time “14:57”. Other information to be provided may include messages, comments, and information left by other users at time of registration. For example, when the information on User C is provided to active User A, the information on User C may include user identification information “User C”, registered POI information “Century Cartoon Game Center”, and message information left at time of registration “A user who recharges 100 game currency will be given another 100 game currency as a present !>_<!”. When the information on other users is provided to the active user, the terminal of the active user can be used, and a plurality of methods can be adopted. The ways may be audio, video, text, short message, or a combination thereof. For example, the information on other users is provided to the active user through a combination of short message and prompt tone. In a specific application, a prompt tone of a short message may be played first, then a prompt box on the short message pops up. The contents in the prompt box is such as “At 10:30 today, Huang Xiaohua left a message at Yaohan: Dears, specialty sushi is very delicious in Nduo Sushi”, as shown in FIG. 3. In the prompt box, “10:30” is a registration time, “Huang Xiaohua” is user identification information, “Yaohan” is information on a registered interest point, and “Dears, specialty sushi is very delicious in Nduo Sushi” is the message information left by the user at time of registration.

As can be seen in various embodiments, after obtaining the information of these other users, the active user may view messages or comments of interest according to the user's own hobbies and interests, thus knowing other points of interest which may be nearby. The active user may send information to a user which the active user is interested in. For example, after active User A sees the message left by Huang Xiaohua, the active user may send to Huang Xiaohua a short message, “Which district of Yaohan is Nduo Sushi in?”. If active User A exchanges with Huang Xiaohua happily, they can then add each other as friends.

In conclusion, on one hand, through using the method for providing user information according to various embodiments of the present disclosure, an active user is provided with information of other users selected according to points of interest, so that the other users provided to the active user are those users closely associated with the geographic location of the active user or associated with the points of interest of the active user. In other words, the selected users are those the active user is more interested in. The active user may acquire more useful information through communication with these users and get to know people with the same hobbies or interests. That is, other users selected under this technical solution fit highly with the active user in terms of hobbies, interests, and other aspects. On the other hand, under the method of providing user information, a server is not needed to make real-time tracking of the position of each user, and the position of each user is identified based on the registration information generated in the process of registering points of interest. In this way, less resource is required.

FIG. 4 illustrates a structure block diagram of a device for providing active user's information according to various embodiments of the present disclosure. The device for providing user information may be a server which can interact with a plurality of mobile terminals. The device for providing user information includes: a position acquiring module 410, a POI acquiring module 420, a user acquiring module 430, and an information providing module 440.

The position acquiring module 410 is configured to acquire information relating to user position of an active user. The position acquiring module 410 may include a first request receiving unit 412 configured to receive the information relating to the user position of the active user. The position acquiring module 410 may also include a second request receiving unit 414 and a user position locating unit 416. The second request receiving unit 414 is configured to receive preliminary locating information of a user, and the user position locating unit 416 is configured to make positioning to obtain the information on the position of the active user according to the preliminary locating information in a query request received by the second request receiving unit 414.

The POI acquiring module 420 is configured to obtain POIs associated with user's position information acquired by the position acquiring module 410. The POI acquiring module 420 may include a first acquisition module 422. The first acquisition module 422 is configured to acquire at least one point of interest having distance with the user position obtained by the position acquiring module 410 less than a predetermined range, as a point of interest associated with the aforesaid user position.

The user acquiring module 430 is configured to acquire other users which have registered on POIs obtained by the POI acquiring module 420 within a predetermined time period. Herein, the registration mainly refers to an operation which associates user identification information, registration time, and registered POI information of a registration initiating user, and generates registration information based on the aforesaid information.

The information providing module 440 is configured to provide an active user with the information on other users obtained by the user acquiring module 430.

The information providing module 440 may include a first information providing unit 442. The first information providing unit 442 is configured to provide the active user with other user's information obtained by the user acquiring module 430 through a predetermined way. The other user's information may include user identification information and registered POI information. The predetermined way may be audio, video, text, short message, or a combination thereof.

In conclusion, on one hand, through using the method for providing user information according to various embodiments of the present disclosure, an active user is provided with information of other users selected according to points of interest so that the other users provided to the active user are those users which are closely associated with the geographic location of the active user, or associated with the points of interest which the active user is interested in. In other words, the selected users are users which the active user is more interested in. The active user may acquire more useful information through communications with these users, and get to know friends with similar hobbies or interests. That is, other users selected under this technical solution fit with the active user in terms of hobbies, interests, and other aspects. On the other hand, through using the device for providing user information, a server is not needed to make real-time tracking of the position of each user, and the position of each user is identified based on the registration information generated in the process of registering points of interest, thereby less resource is required.

It should be noted that when the device for providing user information according to the above embodiment is described in various embodiments, the aforesaid functional modules are illustrated by an example. In a practical application, the allocation of the aforesaid functions can be completed by different functional modules. That is, the internal structure of the device may be divided into different functional modules to complete all or part of the functions described above. In addition, the device for providing user information according to the aforesaid embodiment has the same conception as the embodiment for the method of providing user information. The specific execution process is shown in the embodiment for the method of providing user information, which is not described repeatedly herein.

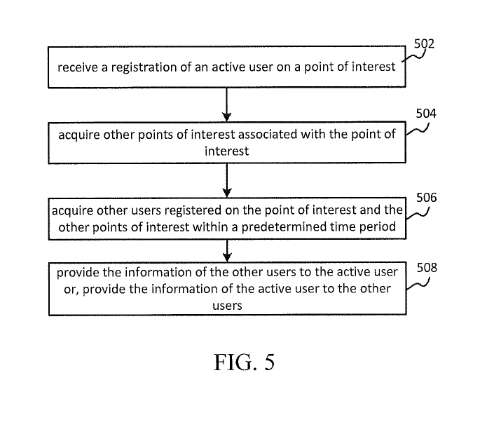

FIG. 5 illustrates the flow chart of a method of providing user information according to various embodiments of the present disclosure. The method of providing user information can be used in a server which may interact with multiple mobile terminals. The method of providing user information includes the following steps:

Step 502: Receive the registration of an active user on a POI.

A point of interest (POI) is a kind of data relating to geographic location. Each POI usually includes information in four aspects: name, category, longitude, and latitude. For example, a specific POI may include: name: “Tongfu Hotel”, category: “Catering service”, longitude: “XX, XX”, latitude: “YY, YY”. The POI is generally combined with map, positioning, and other services to form an application program to be used by one or more users. When a user uses a mobile terminal including a POI-related application program, the user can register at a POI. The registration mainly refers to an operation which associates registered POIs, registration time and user identification information of a registration initiating user, and takes the aforesaid information as registration information. For example, when User A has a meal at Tongfu Hotel at 14:59 p.m. on Feb. 8, 2012, User A may register on the POI of Tongfu Hotel via a mobile terminal. The mobile terminal can store “User A”, “2012/2/8 14:59” and “Tongfu Hotel” as a piece of registration information. In a specific application, the registration herein may adopt other names such as Foot Printing, Sign-in, Gold Prospecting, and Name Signing. During a registration process, the user can also add a message, a comment, or other information into the registration information.

Step 504: Obtain other POIs associated with this POI.

After the active user registers on a point of interest, the server can acquire other POIs associated with this registered point of interest. For example, after the active user registers on the POI “Tongfu Hotel”, the server can obtain all other POIs within 200 meters around the POI “Tongfu Hotel”. For another example, after the active user registers on the POI “Tongfu Hotel”, the server can obtain other POIs under the category “catering service” within 300 meters around the POI “Tongfu Hotel”.

Step 506: Obtain other users which have registered on the POI and other POIs within a predetermined time period.

After acquiring other POIs, the server can continue to obtain other users which have registered on the POI and other POIs within a predetermined time period. In order to obtain other users which may be as useful as possible, the predetermined time period herein generally lasts a short time, such as 30 seconds or 5 minutes. For example, POIs associated with the POI “Tongfu Hotel” obtained in Step 104 may include: a POI “Automatic service area of Bank of China at XX Street”, a POI “Kedi Supermarket”, and a POI “Century Cartoon Game Center”. A server may continue to, within 5 minutes, obtain other users having registered on the POI “Automatic service area of Bank of China at XX Street”, the POI “Kedi Supermarket”, and the POI “Century Cartoon Game Center”. These users having registered at the POIs may include: User B registering at the POI “Automatic service area of Bank of China at XX Street” at 14:57 p.m., User C registering at the POI “Century Cartoon Game Center” at 14:59 p.m. and attaching a message “I have passed the third pass of Taiko Drum Master”, and User D registering at the POI point “Kedi Supermarket” and adding a comment “The butter bread in this Kedi Supermarket is very delicious.”

Step 508: Provide the other user's information to the active user, or provide the active user's information to other users.

After acquiring other users such as User B and User C, the server may provide the information of User B and User C to the active user, and may also provide the information of the active user to other users: User B and User C. The information provided by the server normally includes at least user identification information and registered POI information, and may also include the information which can be provided, such as registration time. For example, when the information on User B is provided to active User A, the information of User B may include user identification information “User B”, registered POI information “Automatic service area of Bank of China at XX Street” and registered time “14:57”. Other information which can be provided may include messages, comments, and other information left by other users at the time of registration. For example, when the information on User C is provided to active User A, the information on User C may include user identification information “User C”, registered POI information “Century Cartoon Game Center” and message information left at the time of registration “A user who recharges 100 game currency will be given another 100 game currency as a present !>_<!”. When the information on other users is provided to the active user, the terminal of the active user can be used, and a plurality of methods can be adopted. The methods may be audio, video, text, short message, or a combination thereof. It is easy to understand that the process of providing the information of the active user to other users is the same as or similar to the process of providing the information on other users to the active user, which is not described repeatedly hereinafter.

In conclusion, on one hand, through using the method for providing user information as provided in various embodiments of the present disclosure, an active user is provided with information of other users selected according to points of interest so that the other users provided to the active user are those users which are closely associated with the geographic location of the active user, or associated with the points of interest which the active user is interested in. In other words, the selected users are users which the active user is more interested in. The active user may acquire more useful information through communication with these users, and get to know friends with the same hobbies or interests. That is, other users selected out under this technical solution fit highly with the active user in terms of hobbies, interests, and other aspects. On the other hand, under the method of providing user information as provided in various embodiments of the present disclosure, a server is not needed to make real-time tracking of the position of each user, and the position of each user is identified based on the registration information generated in the process of registering points of interest, thereby less resource is required.

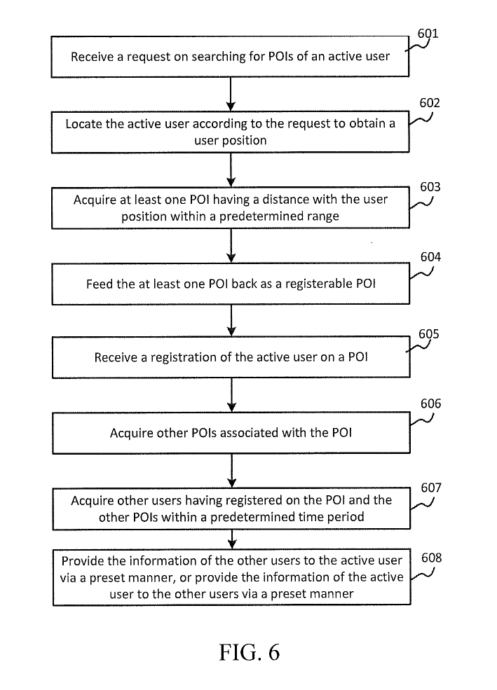

FIG. 6, illustrates the flow chart of a method of providing user information according to various embodiments of the present disclosure. The method of providing user information can be used in a server which may interact with multiple mobile terminals. The method of providing user information includes the following steps:

Step 601: Receive a request on searching for POIs of an active user.

After the active user uses a mobile terminal, the active user may send a request on searching for POIs to a server via this mobile terminal.

Step 602: The server makes positioning of the active user according to the request to obtain user position of the active user.

The server makes positioning to obtain the information on the position of the active user. There are multiple ways for positioning. For example, the mobile terminal adds GPS locating information of the active user to this request, and the server can determine the position of the active user according to the GPS locating information of the active user. For another example, after the server receives from the mobile terminal the request which includes gateway address information obtained when the mobile terminal has access to a mobile network, the server can determine the position of the active user according to the gateway address.

Step 603: Obtain at least one point of interest having a distance with the user position less than a predetermined range.

After the server acquires the user position of the active user, the server can acquire a plurality of POIs having the distance with user's location less than the predetermined range. For example, the user position of the active user acquired by the server is: longitude xx.xx, latitude yy.yy, then according to the longitude and latitude of the user's location and the longitude and latitude of each POI, the server can obtain all POIs not more than 2 km away from the user's location.

Step 604: Obtain the at least one POI as a registerable POI, and feed it back to the active user.

After the server obtains a plurality of POIs, the server may feed these POIs back to the active user as registerable POIs for review and selection.

Step 605: Receive the registration of a user on a POI.

The active user can select a POI from the registerable POIs and register on the POI. The registration mainly refers to an operation which associates registered POIs, registration time, and user identification information of a registration initiating user, and generates registration information according to the aforesaid information. For example, when User A has a meal at Tongfu Hotel at 14:59 p.m. on Feb. 8, 2012, User A may register on the POI of Tongfu Hotel via a mobile terminal. The mobile terminal can store “User A”, “2012/2/8 14:59” and “Tongfu Hotel” as a piece of registration information. In a specific application, the registration herein may adopt other names such as Foot Printing, Sign-in, Gold Prospecting, and Name Signing. During a registration process, the user can also add a message, a comment or other information into the registration information.

Step 606: Obtain other POIs associated with this POI.

After the active user registers on a point of interest, the server can acquire other POIs associated with this registered point of interest. The association may be in terms of geographical location, category, keywords, etc. Specific explanation is given below.

The server can obtain at least one point of interest having distance with the registered POI less than a predetermined scope, as another POI associated with the registered POI. For example, after the active user registers on the POI “Tongfu Hotel”, the server can obtain all other POIs within 200 meters around the POI “Tongfu Hotel”.

The server can obtain at least one point of interest under the same category as the registered POI and, having distance with the registered POI less than a predetermined scope, as another POI associated with the registered POI. For example, after the active user registers on the POI “Tongfu Hotel”, the server can obtain other POIs under the category “catering service” within 300 meters around the POI “Tongfu Hotel”. For example, another POI may be “Ancient Roman Hotel” or I “Fuhao Hotel”.

The server may also obtain other POIs based on whether the names of POIs are associated or based on other association modes, which are not described below.

Step 607: Obtain other users which have registered on the POI and other POIs within a predetermined time period.

After acquiring other POIs, the server can continue to obtain other users which have registered on the POI and these other POIs on which the active user registered within a predetermined time period. In order to obtain other users which may be as useful as possible, the predetermined time period herein generally lasts a short period of time, such as 30 seconds, 5 minutes, and the like. For example, POIs associated with the POI “Tongfu Hotel” obtained in Step 604 may include: a POI “Automatic service area of Bank of China at XX Street”, a POI “Kedi Supermarket”, and a POI “Century Cartoon Game Center”. The server may continue to, within 5 minutes, obtain other users having registered on the POI “Automatic service area of Bank of China at XX Street”, the POI “Kedi Supermarket”, and the POI “Century Cartoon Game Center”. The users having registered on the POIs may include: User B registering at the POI “Automatic service area of Bank of China at XX Street” at 14:57 p.m., User C registering at the POI “Century Cartoon Game Center” at 14:59 p.m. and attaching a message “I have passed the third pass of Taiko Drum Master”, and User D which registers at the POI “Kedi Supermarket” and adds a comment “The butter bread in this Kedi Supermarket is very delicious.”

Step 608: Provide the other user's information to the active user through a predetermined way, or provide the active user's information to other users through a predetermined way.

After acquiring other users, such as User B and User C, the server may provide the information of User B and User C to the active user, and may also provide the information of the active User A to other users, i.e., User B and User C. The information provided by the server normally includes at least user identification information and registered POI information, and may also include the information which can be provided, such as registration time. For example, when the information of User B is provided to active User A, the information of User B may include user identification information “User B”, registered POI information “Automatic service area of Bank of China at XX Street”, and registered time “14:57”. Other information which can be provided may include messages, comments, and information left by other users at time of registration. For example, when the information on User C is provided to active User A, the information on User C may include user identification information “User C”, registered POI information “Century Cartoon Game Center”, and message information left at the time of registration “A user who recharges 100 game currency will be given another 100 game currency as a present !>_<!”. When the information on other users is provided to the active user, the terminal of the active user can be used, and a plurality of methods may be adopted. The methods may be audio, video, text, short message, or a combination thereof. For example, the information on other users is provided to the active user through a combination of short message and prompt tone. In a specific application, a prompt tone of a short message may be played firstly, then a prompt box for the short message pops up. The contents in the prompt box may be, for example, “At 10:30 o'clock today, Huang Xiaohua left a message at Yaohan: Dears, specialty sushi is very delicious in Nduo Sushi”, as shown in FIG. 3. In the message, “10:30” is a registration time, “Huang Xiaohua” is user identification information, “Yaohan” is information on a registered interest point, and “Dears, specialty sushi is very delicious in Nduo Sushi” is the message information left by the user at the time of registration. The process of providing the information of the active user to other users is the same as or similar to the process of providing the information on other users to the active user, which is not described repeatedly hereinafter.

After obtaining the information of these other users, the active user may view messages or comments interesting him according to his own hobbies and interests, thus knowing other points of interest which may be nearby. The active user may send information to the user which the active user is interested in. For example, after the active user sees the message left by Huang Xiaohua, the active user may send to Huang Xiaohua a short message, such as, “Which district of Yaohan is Nduo Sushi in?” If the active user exchanges with Huang Xiaohua happily, they can then add each other as friends.

In conclusion, on one hand, through using the method for providing user information according to various embodiments of the present disclosure, an active user is provided with information of other users selected according to points of interest, so that the other users provided to the active user are those users which are closely associated with interest on POIs registered by the active user, geographic location of the active user, or the time of registration by the active user. In other words, the selected users are users which the active user is more interested in. The active user may acquire more useful information through communication with these users and get to know people with the same hobbies or interests. That is, other users selected under this technical solution fit with the active user in terms of hobbies, interests, and other aspects. On the other hand, under the method of providing user information according to various embodiments of the present disclosure, a server is not needed to make real-time tracking of the position of each user, and the position of each user is identified based on the registration information generated in the process of registering points of interest, therefore, less resource is required.

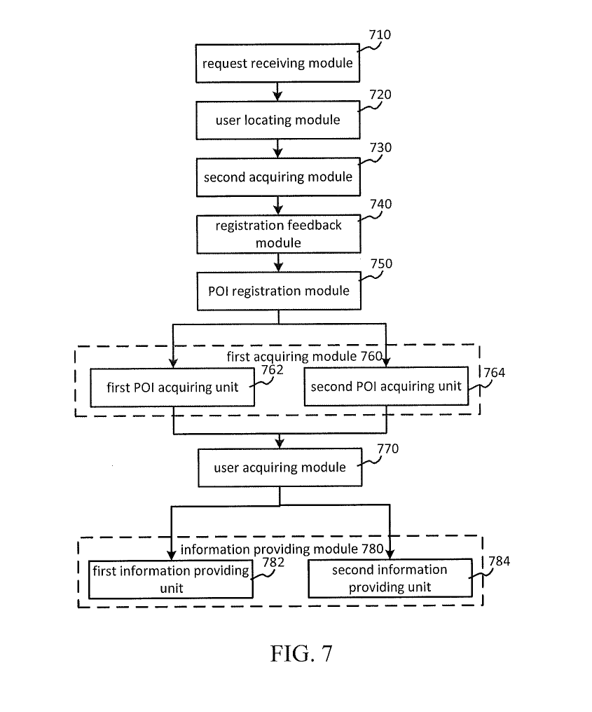

FIG. 7 illustrates a structure block diagram for a device for providing active user's information according to various embodiments of the present disclosure. The device for providing user information may be a server which can interact with a plurality of mobile terminals. The device for providing user information includes: a request receiving module 710, a user positioning module 720, a second acquisition module 730, a registration feedback module 740, a POI registering module 750, a first acquisition module 760, a user acquiring module 770, and an information providing module 780.

The request receiving module 710 is configured to receive a request of an active user on searching for POIs.

The user positioning module 720 is configured to make positioning of the active user to obtain the information on the position of the active user according to the request received by the request receiving module 710.

The second acquisition module 730 is configured to acquire at least one point of interest having distance with the user position obtained by the user positioning module 720 less than a predetermined scope.

The registration feedback module 740 is configured to take at least one POI obtained by the second acquisition module 730 as a registerable POI, and feed it back to the active user.

The POI registering module 750 is configured to receive a user's registration on a POI among at least one POI provided by the registration feedback module 440.

The first acquisition module 760 is configured to acquire other POIs associated with the POI registered via the POI registering module 750. The first acquisition module 760 may include a first POI acquiring unit 762, and/or a second POI acquiring unit 764. The first acquisition module 760 is configured to acquire at least one POI having distance with the POI registered via the POI registering module 750 less than a predetermined scope, as other POIs associated with the POI registered via the POI registering module 750. The second POI acquiring unit 764 is configured to acquire at least one point of interest under the same category as the registered POI and having distance with the aforesaid POI less than a predetermined scope, as other POI associated with the registered POI.

A user acquiring module 770 is configured to acquire other users which have registered on the POI via the POI registering module 750 and other POIs acquired by the first acquisition module 760 within a predetermined time period.

The information providing module 780 is configured to provide the information on the active user and other users acquired by the user acquiring module 770 to each other. That is, the information providing module 780 may provide the information on other users acquired by the user acquiring module 770 to the active user, or may provide the information on the active user to other users. The information providing module 780 may include a first information providing unit 782 and/or a second information providing unit 784. The first information providing unit 782 is configured to provide the information on the active user to other users acquired by the user acquiring module 770 through a predetermined way, wherein the information may include user identification information and registered POI information. The second information providing unit 784 is configured to provide the information on other users to the active user through a predetermined way, wherein the information may include user identification information and registered POI information.

In conclusion, on one hand, through using the device for providing user information according to various embodiments of the present disclosure, an active user is provided with information of other users selected according to points of interest, so that the other users provided to the active user are those users which are closely associated with the POI registered by the active user on interests, geographic location, or the time of registration. In other words, the selected users are users which the active user is more interested in. The active user may acquire more useful information through communications with these users, and get to know people with the same hobbies or interests. That is, other users selected under this technical solution fit highly with the active user in terms of hobbies, interests, and other aspects. On the other hand, under the device of providing user information according to various embodiments of the present disclosure, a server is not needed to make real-time tracking of the position of each user, and the position of each user is identified based on the registration information generated in the process of registering points of interest, therefore, less resource is required.

Those with ordinary skill in the art will understand that all or part of the steps for achieving the above embodiments can be completed by hardware and by programs instructing relevant hardware. The aforesaid programs can be stored in a computer readable storage medium, which may be ROM, disc, CD-ROM, etc.

The sequence numbers of the above embodiments of the disclosure are only for the purpose of description, and do not represent one embodiment is superior to another.

The above are only some examples of the disclosure, and are not be configured to restrict the disclosure. Any modification, equivalent replacement, improvement, and the like within the spirit and principle of the disclosure should be included in the protection scope of the disclosure.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Reference throughout this specification to “one embodiment,” “an embodiment,” “specific embodiment,” or the like in the singular or plural means that one or more particular features, structures, or characteristics described in connection with an embodiment is included in at least one embodiment of the present disclosure. Thus, the appearances of the phrases “in one embodiment” or “in an embodiment,” “in a specific embodiment,” or the like in the singular or plural in various places throughout this specification are not necessarily all referring to the same embodiment. Furthermore, the particular features, structures, or characteristics may be combined in any suitable manner in one or more embodiments.

What is claimed is:

1. A method for providing user information, comprising:
acquiring information relating to user position of a user;
acquiring a point of interest associated with the user position;
acquiring other users who have performed registration on the point of interest within a predetermined time period; and
providing information of the other users to the user.

2. The method according to claim 1, wherein acquiring the information relating to the user position of the user comprises:
receiving preliminary locating information of the user; and
positioning the user according to the preliminary locating information to obtain the information relating to the user position.

3. The method according to claim 1, wherein acquiring the point of interest associated with the user position comprises:
acquiring at least one point of interest having a distance with the user position less than a predetermined range as the point of interest associated with the user position.

4. The method according to claim 1, wherein providing the information of the other users to the user comprises:
providing the information of the other users to the user through a predetermined way;
wherein the information comprises user identification information and registered POI information; and
the predetermined way comprises at least one of the following ways including audio, video, text, and short message.

5. The method according to claim 1, wherein the registration comprises: associating the user identification information, registration time and the registered POI information of a registration initiating user to generate registration information.

6. A device for providing user information, comprising:
a position acquiring module, configured to acquire information relating to user position of a user;
a POI acquiring module, configured to acquire a point of interest associated with the user position;
a user acquiring module, configured to acquire other users who have performed registration on the point of interest within a predetermined time period;
an information providing module, configured to provide information of the other users to the user;
wherein the registration comprises: associating user identification information, registration time, and registered POI information of a registration initiating user to generate registration information.

7. The device according to claim 6, wherein the position acquiring module comprises: a request receiving unit, and a user position locating unit;
wherein the request receiving unit is configured to receive preliminary locating information of the user; and
the user position locating unit is configured to locate the user according to the preliminary locating information to obtain the user position.

8. The device according to claim 6, wherein the POI acquiring module comprises: a first acquiring unit;
wherein the first acquiring unit is configured to acquire at least one point of interest having a distance with the user position less than a predetermined range as the point of interest associated with the user position.

9. The device according to claim 6, wherein the information providing module comprises: a first information providing unit;
wherein the first information providing unit is configured to provide the user with the information of the other users through a predetermined way; wherein the information comprises user identification information and registered POI information, and the predetermined way comprises at least one of the following ways including audio, video, text, and short message.

10. A method for providing user information, comprising:
receiving registration of a user on a point of interest;
acquiring other points of interest associated with the point of interest;
acquiring other users registered on the point of interest and the other points of interest within a predetermined time period; and
providing information of the other users to the user, or providing information of the user to the other users.

11. The method according to claim 10, wherein acquiring the other points of interest associated with the point of interest comprises:
acquiring at least one point of interest having a distance with the point of interest less than a predetermined range as the other points of interest associated with the point of interest.

12. The method according to claim 10, wherein acquiring the other points of interest associated with the point of interest comprises:
acquiring at least one point of interest under the same category and having a distance with the point of interest less than a predetermined range as the other points of interest associated with the point of interest.

13. The method according to claim 10, wherein providing the information of the other users to the user, or providing the information of the user to the other users comprises:
providing the information of the other users to the user through a predetermined way, wherein the information includes user identification information and registered POI information;
or, providing the information of the user to the other users through a predetermined way, wherein the information includes user identification information and registered POI information;
wherein the predetermined way comprises at least one of audio, video, text, and short message.

14. The method according to claim 10, before receiving the registration of the user on the point of interest, further comprising:
receiving a request of the user on searching for POIs;
locating the user according to the request to obtain the user position;
acquiring at least one point of interest having the distance with the user position less than the predetermined range; and
obtaining the at least one point of interest as a registerable POI for feedback.

15. A device for providing user information, comprising:
a POI registering module, configured to receive registration from a user;
a first acquiring module, configured to acquire other points of interest associated with the point of interest;
a user acquiring module, configured to acquire other users which have registered on the point of interest and the other points of interest within a predetermined time period; and
an information providing module, configured to provide information of the other users to the user, or provide information of the user to the other users.

16. The device according to claim 15, wherein the first acquiring module comprises: a first POI acquiring unit; and
the first POI acquiring unit is configured to obtain at least one point of interest having a distance with the point of interest less than a predetermined range as the other points of interest associated with the point of interest.

17. The device according to claim 15, wherein the first acquiring module comprises: a second POI acquiring unit; and
the second POI acquiring unit is configured to acquire at least one point of interest under the same category and having a distance with the point of interest less than a predetermined range as the other points of interest associated with the point of interest.

18. The device according to claim 15, wherein the information providing module comprises: a first information providing unit, and/or a second information providing unit; and
the first information providing unit is configured to provide the information of the user to the other users through a predetermined way, wherein the information includes user identification information and registered POI information;
the second information providing unit is configured to provide the information of the other users to the user through a predetermined way, wherein the information includes user identification information and registered POI information;
wherein the predetermined way includes at least one of audio, video, text, and short message.

19. The device according to claim 15, further comprising: a request receiving module, a user position locating module, a second acquiring module, and a registration feedback module;
wherein the request receiving module is configured to receive a request of the user on searching for POIs;
the user position locating module is configured to locate the user according to the request to obtain the user position;
the second acquiring module is configured to obtain at least one point of interest having the distance with the user position less than the predetermined range; and
the registration feedback module is configured to obtain the at least one point of interest as a registerable POI for feedback.
